(19) United States
(12) Patent Application Publication
(10) Pub. No.: US 2022/0082201 A1
(43) Pub. Date: Mar. 17, 2022

(54) COMPUTER BRACKET

(71) Applicant: SWIFF TECHNOLOGY CO.,LTD., Shenzhen (CN)

(72) Inventor: He Jia, Guangdong (CN)

(21) Appl. No.: 17/035,740

(22) Filed: Sep. 29, 2020

(30) Foreign Application Priority Data
Sep. 11, 2020 (CN) 202010952717.1
Sep. 11, 2020 (CN) 202021990711.5

(51) Int. Cl. F16M 11/10; F16B 47/00

(52) U.S. Cl. CPC F16M 11/10; F16B 47/00

(57) ABSTRACT

A computer bracket, including a support part, a load-bearing part for carrying a computer, a connection assembly for connecting the support part and the load-bearing part, and the computer bracket also includes a first driving assembly; the connection assembly includes an upper mounting member; the first driving assembly is provided with a driving end and a rotating output end; the first driving assembly drives the load-bearing part to rotate relative to the upper mounting member, so that the load-bearing part is inclined or parallel to the support part. The first driving assembly drives the load-bearing part to rotate so that the load-bearing part is inclined or parallel to the support part, and the tilt angle of the computer placed on the load-bearing part is adjusted. The first driving assembly to drive the load-bearing part to rotate, overcomes the technical problem that the computer bracket cannot automatically rotate.

### CROSS REFERENCE TO RELATED DISCLOSURE

This disclosure claims priority benefit of Chinese Patent disclosure No. 202010952717.1 and No. 202021990711.5, and the entire contents of which are incorporated herein by reference.

### TECHNICAL FIELD

The present disclosure relates to the field of digital product accessories, in particular to a computer bracket.

### BACKGROUND

At present, the existing computer bracket on the market basically adopts the structure of damping shaft to resist the mass of computer or the supported object. Therefore, it is necessary to use the damping shaft with larger damping coefficient, and the greater the damping coefficient, the greater the force required to operate the bracket. Because the computer bracket can not automatically rotate to adjust the angle, it is very inconvenient for the elderly, children or people with other movement disorders to rely on external force or ask for help from others.

### SUMMARY

The present disclosure is to provide a computer bracket to solve the technical problem that the existing computer bracket cannot automatically rotate and adjust the angle.

In order to solve the above technical problem, the present disclosure is to provide a computer bracket, wherein the computer bracket includes a support part, a load-bearing part for carrying a computer, and a connection assembly for connecting the support part and the load-bearing part. Wherein that the computer bracket further includes a first driving assembly. The connection assembly includes an upper mounting member, and the first driving assembly is provided with a driving end and a rotating output end. The driving end is fixedly connected to the load-bearing part or the upper mounting member; the rotating output end is fixedly connected to the upper mounting member or the load-bearing part; the first driving assembly drives the load-bearing part to rotate relative to the upper mounting member, so that the load-bearing part is inclined or parallel to the support part.

Further, the computer bracket includes a PCB (printed circuit board), the support part is provided with a control button electrically connected with the PCB, and the first driving assembly is electrically connected with the PCB.

Further, the upper mounting member is provided with a first limiting switch and a second limiting switch which are electrically connected with the PCB. The computer bracket further includes a connection bracket, a limit trigger piece used to trigger the second limiting switch. The limit trigger piece is clamped and fixed with the connection bracket, and the first limiting switch is triggered when the load-bearing part is rotated parallel to the support part.

Further, the first driving assembly is a turbine self-locking motor.

Further, the upper mounting member is provided with a power interface electrically connected with the PCB.

Further, the support part is provided with a lower mounting end. The computer bracket further includes a second driving assembly, and the second driving assembly drives the connection assembly to rotate around the lower mounting end.

Further, the connection assembly includes a first connecting piece and a second connecting piece. Two ends of the first connecting piece are respectively rotationally connected with the upper mounting member and the lower mounting end. Two ends of the second connecting piece are respectively rotationally connected with the upper mounting member and the lower mounting end. The first connecting piece, the second connecting piece, the upper mounting member and the lower mounting end form a parallelogram hinge structure. And the second driving assembly drives the first connecting piece and the second connecting piece close to or far away from each other, so as to make the connection assembly rotate around the lower mounting end.

Further, the second driving assembly includes a reduction motor, a screw rod connected with the reduction motor, and a nut connected with the screw rod. The reduction motor is rotationally connected with the first connecting piece, the nut is rotationally connected with the second connecting piece, and the reduction motor drives the screw rod to rotate, so as to make the first connecting piece and the second connecting piece is close to or away from each other.

Further, the lower mounting end is provided with a third limiting switch, the second driving assembly triggers the third limit switch when the first connecting piece and the second connecting piece are parallel to an upper end surface of the support part.

Further, the load-bearing part is provided with a non-slip pad or suction cup.

The embodiment of the present disclosure provides a computer bracket, which drives the load-bearing part to rotate by the first driving assembly, so that the load-bearing part is inclined or parallel to the support part, and the tilt angle of the computer placed on the load-bearing part can be adjusted according to the use requirements. The present disclosure adopts the technical means of the first driving assembly to drive the load-bearing part to rotate, so as to overcome the technical problem that the computer bracket cannot automatically rotate and adjust the angle, and achieves the technical effect of automatically adjusting the computer bracket.

Besides, the second driving component drives the connection assembly to rotate around the lower mounting end, so as to adjust the distance between the load-bearing part and the supporting part.

The present disclosure is further described in combination with the attached drawings and specific embodiments.

### BRIEF DESCRIPTION OF THE DRAWINGS

FIG. 1 is a first perspective view of a computer bracket of the present disclosure;

FIG. 2 is an exploded view of a connection assembly and a lower mounting end of the present disclosure;

FIG. 3 is a second perspective view of the computer bracket of the present disclosure.

### DESCRIPTION OF DRAWING LABELS

1 support part
11 lower mounting end
111 the third limiting switch
2 load-bearing part
21 non-slip part
22 non-slip bump
3 connection assembly
31 upper mounting member
311 the first limiting switch
312 the second limiting switch
32 the first connecting piece
33 the second connecting piece
4 the first driving assembly
5 connection bracket
6 the second driving assembly
61 reduction motor
62 screw rod
63 nut
7 PCB (printed circuit board)
8 control button
9 limit trigger piece.

### DETAILED DESCRIPTION OF THE EMBODIMENTS

In order to fully understand the technical content of the present disclosure, the technical solution of the present disclosure is further introduced and explained in combination with the drawings, but not limited to this.

In the embodiment of the present disclosure, if there is directional indication (such as up, down, left, right, front, rear . . . ), it is only used to explain the relative position relationship, motion situation, etc. between the components under a certain position (as shown in the attached figure). If the specific position changes, the directional indication will change accordingly.

In addition, the description of “first”, “second” and the like in the present disclosure is only for the purpose of description, and cannot be understood as indicating or implying their relative importance or implicitly indicating the quantity of the indicated technical features. Thus, the features defined as “first” and “second” may explicitly or implicitly include at least one of the features.

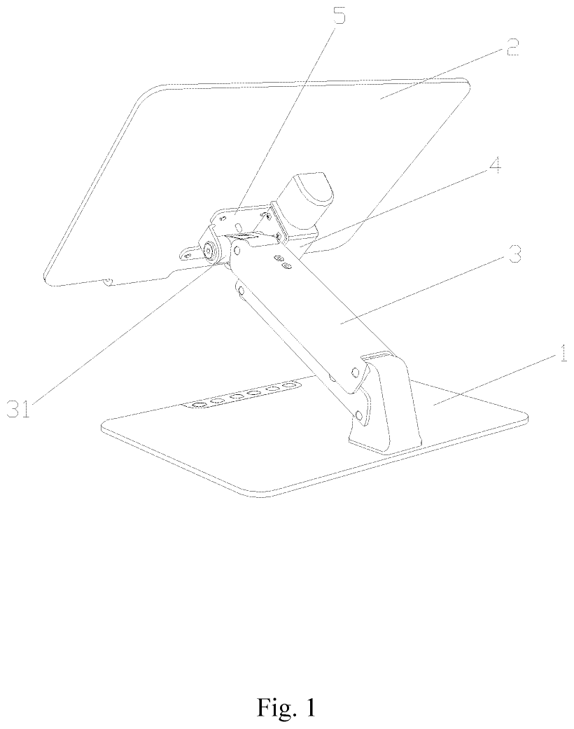

As shown in FIG. 1, the computer bracket includes a support part 1, a load-bearing part 2 for carrying a computer, a connection assembly 3 for connecting the support part 1 and the load-bearing part 2, and a first driving assembly 4.

Preferably, the connection assembly 3 includes an upper mounting member 31, and the computer bracket also includes a connection bracket 5. The connection bracket 5 is rotationally connected with the upper mounting member 31, and the connection bracket 5 is fixed at the bottom of the load-bearing part 2.

Preferably, the first driving assembly 4 is provided with a driving end and a rotating output end. The driving end is fixedly connected with the load-bearing part 2, and the rotating output end is fixedly connected with the upper mounting member 31. The first driving assembly 4 drives the load-bearing part 2 to rotate relative to the upper mounting member 31, so that the load-bearing part 2 is inclined or parallel to the support part 1. When in use, the tilt angle of the computer placed on the load-bearing part 2 can be adjusted through the first driving assembly 4 according to the use requirements.

Preferably, the first driving assembly 4 is a turbine self-locking motor, and the turbine self-locking motor is fixed on the connection bracket 5.

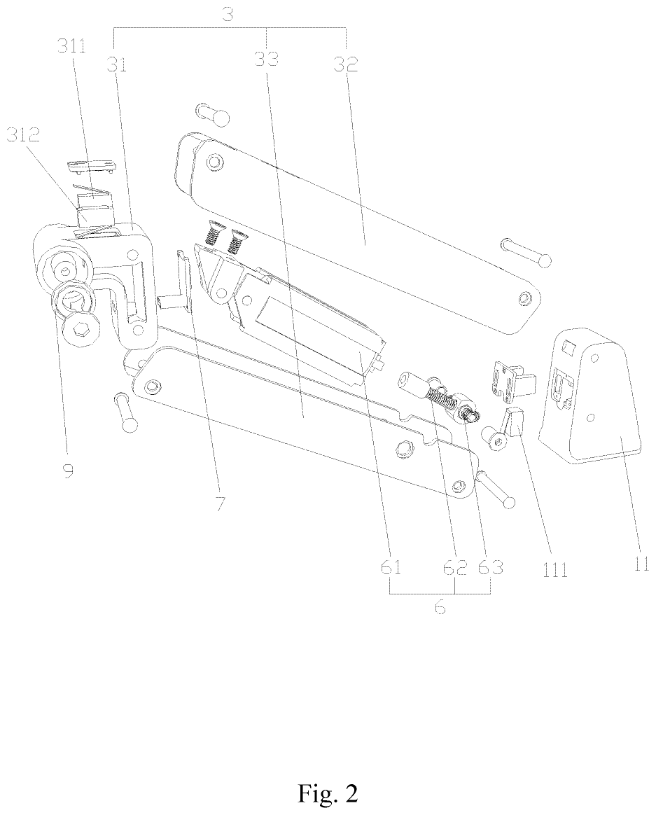

As shown in FIG. 2, the computer bracket also includes a PCB 7, the upper mounting member 31 is provided with a first limiting switch 311 and a second limiting switch 312 which are electrically connected with the PCB 7, and the first driving assembly 4 is electrically connected with the PCB 7. When the load-bearing part 2 rotates parallel to the support part 1, the load-bearing part 2 triggers the first limiting switch 311 to avoid position interference between the load-bearing part 2 and the upper mounting member 31.

Preferably, the computer bracket is also provided with a limit trigger piece 9. The limit trigger piece 9 is fixed with the connection bracket 5, which is clamped and fixed with the connection bracket 5. When the load-bearing part 2 is rotated to an angle close to 80° with the support part, the limit trigger piece 9 triggers the second limiting switch 312 to prevent the computer placed on the load-bearing part 2 from overturning due to the continuous rotation of the load-bearing part 2.

Preferably, the support part 1 is provided with a lower mounting end 11. The computer bracket also includes a second driving assembly 6 electrically connected with the PCB 7, and the second driving assembly 6 drives the connection assembly 3 to rotate around the lower mounting end 11. In the present embodiment, the lower mounting end 11 is a separate component, and in other embodiments, the support part and the lower mounting end are in an integral structure.

Preferably, the connection assembly 3 also includes a first connecting piece 32 and a second connecting piece 33. Both ends of the first connecting piece 32 are rotationally connected to the upper mounting member 31 and the lower mounting end 11, respectively. And both ends of the second connecting piece 33 are rotationally connected to the upper mounting member 31 and the lower mounting end 11, respectively. The first connecting piece 32, the second connecting piece 33, the upper mounting member 31 and the lower mounting end 11 form a parallelogram hinge structure. The second driving assembly 6 drives the first connecting piece 32 and the second connecting piece 33 close to or away from each other, so as to make the connection assembly 3 rotate around the lower mounting end 11, so as to adjust the distance between the load-bearing part 2 and the support part 1. In use, it can be understood as adjusting the height of the load-bearing part 2.

Preferably, the sections of the first connecting piece 32 and the second connecting piece 33 are U-shaped, and the U-shaped groove between the two forms a cavity for installing the second driving assembly 6. In this embodiment, the second connecting piece 33 can be inserted into the U-shaped groove of the first connecting piece 32.

Preferably, the second driving assembly 6 includes a reduction motor 61, a screw rod 62 connected with the reduction motor 61 and a nut 63 connected with the screw rod 62. The reduction motor 61 is rotationally connected with the first connecting piece 32, and the nut 63 is rotationally connected with the second connecting piece 33. Specifically, both sides of the nut 63 are rotationally connected with the second connecting piece 33 through a rotating shaft. The reduction motor 61 drives the screw rod 62 to rotate so that the first connecting piece 32 and the second connecting piece 33 are close to or away from each other.

Preferably, the lower mounting end 11 is also provided with a third limiting switch 111 electrically connected with the PCB. When the first connecting piece 32 and the second connecting piece 33 are parallel to the upper end surface of the support part 1, the length of the screw rod 62 extending out of the nut 63 is the longest. At this time, the second driving assembly 6 triggers the third limiting switch 111 to avoid the position interference caused by the continuous rotation of the connection assembly 3.

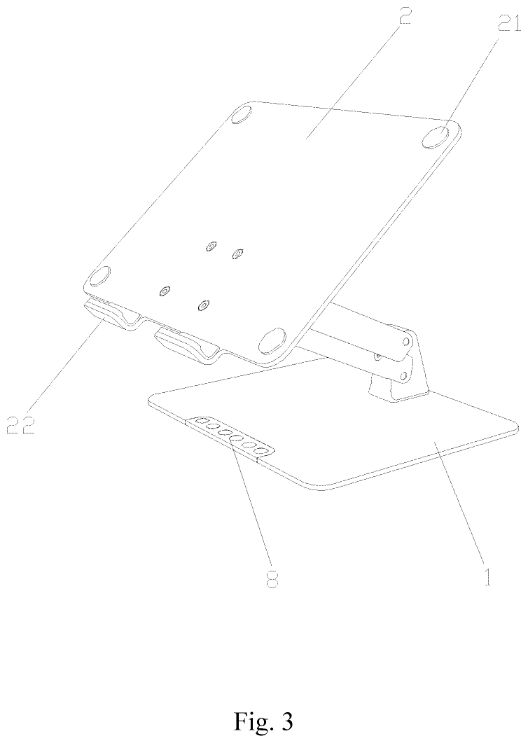

As shown in FIG. 3, the load-bearing part 2 is also provided with a non-slip pad 21 and a non-slip bump 22 at the bottom.

The support part 1 is provided with a control button 8 which is electrically connected with the PCB 7, and the upper mounting member is further provided with a power interface electrically connected with the PCB. The user can control the action of the first driving assembly and the second driving assembly by the control button 8 on the support part 1, so as to control the height and tilt angle of the load-bearing part 2 and the support part 1, so that the function of adjusting the height and tilt angle of the computer placed on the load-bearing part 2 can be achieved.

In other embodiments, the driving end is fixedly connected with the upper mounting member, and the rotating output end is fixedly connected with the load-bearing part.

In other embodiments, the load-bearing part is also provided with a suction cup.

Although the embodiments of the present disclosure have been shown and described, it should be understood to those ordinary skilled person in the art that a variety of changes, modifications, substitutions and transformation can be made to these embodiments without departing from the principle and spirit of the present disclosure, and the scope of the present disclosure is limited by the attached claims and their equivalent scopes.

What is claimed is:

1. A computer bracket, comprising a support part, a load-bearing part for carrying a computer, and a connection assembly for connecting the support part and the load-bearing part, wherein that the computer bracket further comprises a first driving assembly; the connection assembly comprises an upper mounting member; the first driving assembly is provided with a driving end and a rotating output end; the driving end is fixedly connected to the load-bearing part or the upper mounting member; the rotating output end is fixedly connected to the upper mounting member or the load-bearing part; the first driving assembly drives the load-bearing part to rotate relative to the upper mounting member, so that the load-bearing part is inclined or parallel to the support part.

2. The computer bracket according to claim 1, wherein the computer bracket comprises a PCB (printed circuit board); the support part is provided with a control button electrically connected with the PCB; and the first driving assembly is electrically connected with the PCB.

3. The computer bracket according to claim 2, wherein the upper mounting member is provided with a first limiting switch and a second limiting switch which are electrically connected with the PCB; the computer bracket further comprises a connection bracket, a limit trigger piece used to trigger the second limiting switch; the limit trigger piece is clamped and fixed with the connection bracket; the first limiting switch is triggered when the load-bearing part is rotated parallel to the support part.

4. The computer bracket according to claim 3, wherein the first driving assembly is a turbine self-locking motor.

5. The computer bracket according to claim 3, wherein the upper mounting member is provided with a power interface electrically connected with the PCB.

6. The computer bracket according to claim 1, wherein the support part is provided with a lower mounting end; the computer bracket further comprises a second driving assembly; the second driving assembly drives the connection assembly to rotate around the lower mounting end.

7. The computer support according to claim 6, wherein the connection assembly comprises a first connecting piece and a second connecting piece; both ends of the first connecting piece are respectively rotationally connected with the upper mounting member and the lower mounting end; two ends of the second connecting piece are respectively rotationally connected with the upper mounting member and the lower mounting end; the first connecting piece, the second connecting piece, the upper mounting member and the lower mounting end form a parallelogram hinge structure; and the second driving assembly drives the first connecting piece and the second connecting piece close to or far away from each other, so as to make the connection assembly rotate around the lower mounting end.

8. The computer support according to claim 7, wherein the second driving assembly comprises a reduction motor, a screw rod connected with the reduction motor, and a nut connected with the screw rod; the reduction motor is rotationally connected with the first connecting piece; the nut is rotationally connected with the second connecting piece; and the reduction motor drives the screw rod to rotate, so as to make the first connecting piece and the second connecting piece is close to or away from each other.

9. The computer bracket according to claim 7, wherein the lower mounting end is provided with a third limiting switch; the second driving assembly triggers the third limit switch when the first connecting piece and the second connecting piece are parallel to an upper end surface of the support part.

10. The computer bracket according to claim 1, wherein the load-bearing part is provided with a non-slip pad or a suction cup.
